(19) United States
(12) Patent Application Publication
(10) Pub. No.: US 2014/0293237 A1
(43) Pub. Date: Oct. 2, 2014

(54) PROJECTOR

(71) Applicant: Funai Electric Co., Ltd., Osaka (JP)

(72) Inventor: Yoshimizu NAKAO, Daito-shi (JP)

(73) Assignee: Funai Electric Co., Ltd., Osaka (JP)

(21) Appl. No.: 14/217,877

(22) Filed: Mar. 18, 2014

(30) Foreign Application Priority Data
Mar. 29, 2013 (JP) 2013-071806

(51) Int. Cl. G03B 21/28

(52) U.S. Cl. CPC G03B 21/28
USPC 353/31; 353/98

(57) ABSTRACT

A projector includes laser light sources which emit light, a MEMS mirror which operates at specified angles of deflection so as to scan light emitted from the laser light sources over a projection area at a sine-function angular velocity in which a scanning speed in a vicinity of a central portion of the projection area in a horizontal direction is faster than a scanning speed in a vicinity of end portions, and a first lens which is disposed at a position between the MEMS mirror and the projection area and which refracts light scanned by the scanner such that the scanning speed of the light scanned by the MEMS mirror in the vicinity of the central portion of the projection area in the horizontal direction is equal or substantially equal to the scanning speed in the vicinity of the end portions in the horizontal direction.

### BACKGROUND OF THE INVENTION

1. Field of the Invention

The present invention relates to a projector and particularly to a projector including a scanner.

2. Description of the Related Art

Projectors including scanners have been known in the past (for example, see Japanese Patent Application Laid-Open Publication No. 2009-258569).

Japanese Patent Application Laid-Open Publication No. 2009-258569 discloses a projector including a red laser light source, a green laser light source, and a blue laser light source that emit light, and a MEMS mirror (scanner) that operates on the light emitted from the three laser light sources at specified angles of deflection. MEMS mirrors such as that recited in the Japanese Patent Application Laid-Open Publication No. 2009-258569 are known to operate at specified angles of deflection so as to scan light emitted from the various laser light sources over the projection area at a sine-function angular velocity which is such that the scanning speed in the vicinity of the central portion of the projection area in the horizontal direction is faster than the scanning speed in the vicinity of the end portions.

However, with a projector such as that described in the Japanese Patent Application Laid-Open Publication No. 2009-258569, a MEMS mirror is provided which operates such that the scanning speed in the vicinity of the central portion of the projection area in the horizontal direction becomes faster than the scanning speed in the vicinity of the end portions as described above, so the scanning time per unit of surface area (amount of radiated light (amount of light)) in the vicinity of the central portion of the projection area in the horizontal direction becomes less than the scanning time per unit of surface area (amount of radiated light (amount of light)) in the vicinity of the end portions. As a result, there is thought to be a problem in that the luminance (brightness) in the vicinity of the central portion of the projection area in the horizontal direction drops compared to the luminance (brightness) in the vicinity of the end portions.

In order to solve the aforementioned problem, a countermeasure is conceivable in which the amount of light per unit of surface area in the vicinity of the end portions is reduced (the optical output is decreased while scanning over the vicinity of the end portions) so as to match the amount of light per unit of surface area in the vicinity of the central portion.

However, with such a countermeasure, there is a problem in that the luminance (brightness) of the entire screen is decreased because the optical output is decreased while scanning over the vicinity of the end portions.

### SUMMARY OF THE INVENTION

Preferred embodiments of the present invention provide a projector with which luminance (brightness) of an entire screen is kept constant or substantially constant while preventing any drop in the luminance (brightness) of the entire screen even in cases where a scanner is provided to operate such that a scanning speed in a vicinity of a central portion of a projection area in a horizontal direction becomes faster than a scanning speed in a vicinity of end portions.

A projector according to a preferred embodiment of the present invention includes a light source which emits light; a scanner which operates at specified angles of deflection so as to scan light emitted from the light source over the projection area at a sine-function angular velocity in which the scanning speed in the vicinity of the central portion of the projection area in the horizontal direction is faster than the scanning speed in the vicinity of the end portions; and an optical member which is disposed at a position between the scanner and the projection area and which refracts light scanned by the scanner such that the scanning speed of the light scanned by the scanner in the vicinity of the central portion of the projection area in the horizontal direction is equal or substantially equal to the scanning speed in the vicinity of the end portions in the horizontal direction.

As was described above, with the projector according to the present preferred embodiment of the present invention, by providing an optical member which is disposed at a position between the scanner and the projection area and which refracts light scanned by the scanner such that the scanning speed of the light scanned by the scanner in the vicinity of the central portion of the projection area in the horizontal direction is equal or substantially equal to the scanning speed in the vicinity of the end portions in the horizontal direction, it is possible to compensate for the scanning time per unit of surface area in the vicinity of the central portion of the projection area in the horizontal direction so as to be equal or substantially equal to the scanning time per unit of surface area in the vicinity of the end portions of the projection area in the horizontal direction, so it is possible to significantly reduce or prevent any differences in the scanning time per unit of surface area (time of radiation of light (amount of radiated light)) between the vicinity of the central portion and the vicinity of the end portions of the projection area in the horizontal direction. Consequently, it is possible to significantly reduce or prevent cases in which the scanning time per unit of surface area (amount of radiated light) in the vicinity of the central portion of the projection area in the horizontal direction is less than the scanning time per unit of surface area (amount of radiated light) in the vicinity of the end portions, so the luminance (brightness) of the entire screen is kept constant or substantially constant while preventing any drop in the luminance (brightness) of the entire screen.

In the projector according to the above-described preferred embodiment of the present invention, the optical member is preferably configured so as to refract light scanned by the scanner such that the scanning speed of the light scanned by the scanner in the vicinity of the central portion of the projection area in the horizontal direction is equal or substantially equal to the scanning speed in the vicinity of the end portions in the horizontal direction, thus making the scanning coordinate in the projection area scanned by the scanner proportional or substantially proportional to the scanning time. With such a configuration, it is possible to perform compensation such that the scanning time in the vicinity of the central portion of the projection area in the horizontal direction coincides or substantially coincides with the scanning time in the vicinity of the end portions of the projection area in the horizontal direction; therefore, it is possible to easily make the time of radiation of light per unit of surface area (amount of radiated light) in the vicinity of the central portion of the projection area in the horizontal direction coincide or substantially coincide with the amount of radiation per unit of surface area in the vicinity of the end portions. As a result, it is possible to keep the luminance (brightness) of the image constant or substantially constant between the vicinity of the central portion and the vicinity of the end portions of the projection area in the horizontal direction without any drop in the luminance (brightness) of the entire screen.

In the projector according to the above-described preferred embodiment of the present invention, the optical member preferably includes a first lens which refracts light scanned by the scanner such that the scanning speed of the light in the vicinity of the central portion of the projection area in the horizontal direction is equal or substantially equal to the scanning speed in the vicinity of the end portions in the horizontal direction. If such a configuration is adopted, the first lens is used to compensate for the scanning speed of light scanned by the scanner (the speed at which light is scanned over the projection area), thus making it possible to easily compensate for the scanning time in the vicinity of the central portion of the projection area in the horizontal direction so as to be equal or substantially equal to the scanning time in the vicinity of the end portions of the projection area in the horizontal direction. Therefore, it is possible to significantly reduce or prevent any differences in the scanning time per unit of surface area (time of radiation of light (amount of radiated light)) between the vicinity of the central portion and the vicinity of the end portions of the projection area in the horizontal direction while significantly reducing or preventing any drop in the luminance (brightness) of the entire screen.

In this case, the first lens is preferably configured such that, in cases where the angle of deflection of the scanner is substantially at the minimum, it refracts light so as to change the scanning coordinate of the light scanned by the scanner such that the scanning speed of the light in the vicinity of the central portion of the projection area in the horizontal direction is equal or substantially equal to the scanning speed in the vicinity of the end portions in the horizontal direction, but in cases where the angle of deflection of the scanner is substantially at the maximum, it refracts light such that the scanning coordinate of the light scanned over the projection area is unchanged. By adopting such a configuration, it is possible to perform compensation such that the scanning time in the vicinity of the central portion of the projection area in the horizontal direction is equal or substantially equal to the scanning time in the vicinity of the end portions of the projection area in the horizontal direction while significantly reducing or preventing any changes to the size or shape of the image projected onto the projection area.

In the above-described configuration which includes the first lens, it is preferable that the light source include a plurality of light sources each of which emits light having a different wavelength, that a second lens be further provided which is disposed at a position between the scanner and the projection area and which corresponds to the wavelengths of light respectively emitted from the plurality of light sources, and that the second lens be configured so as to refract the light of the plurality of different wavelengths respectively emitted from the plurality of light sources and refracted by the first lens to substantially the same scanning coordinate in the projection area. With such a configuration, the second lens compensates for any aberration arising when the light having different wavelengths is refracted by the first lens, so it is possible to significantly reduce or prevent any drop in the resolution of the image.

In the projector according to the above-described preferred embodiment, it is preferable that the scanner include an oscillating mirror element that scans the light emitted from the light source(s) over the projection area at a sine-function angular velocity and that the optical member be configured so as to refract light scanned by the scanner such that the scanning speed of the light scanned by the oscillating mirror element in the vicinity of the central portion of the projection area in the horizontal direction is equal or substantially equal to the scanning speed in the vicinity of the end portions in the horizontal direction. If such a configuration is adopted, even in cases where an oscillating mirror element is used, it is possible to compensate for the scanning time in the vicinity of the central portion of the projection area in the horizontal direction so as to be equal or substantially equal to the scanning time in the vicinity of the end portions of the projection area in the horizontal direction, so it is possible to significantly reduce or prevent any differences in the scanning time per unit of surface area (time of radiation of light) between the vicinity of the central portion and the vicinity of the end portions of the projection area in the horizontal direction while preventing any drop in the luminance (brightness) of the entire screen.

In the projector according to the above-described preferred embodiment, it is preferable that the optical member be configured such that the relationship among the scanning coordinate h in the horizontal direction of the light scanned over the projection area by the scanner, the distance L from the scanner to the projection area, the resonance frequency f of the scanner, the maximum angle of deflection θ₀/2 at which the scanner can operate, the scanning time t scanned by the scanner, and the degree of compensation α making the scanning speed in the vicinity of the central portion of the projection area in the horizontal direction closer to the scanning speed in the vicinity of the end portions in the horizontal direction satisfies the function h=2πfL·(tan θ₀/sin⁻¹ (α))×t. With such a configuration, by adjusting the degree of compensation α, it is possible to easily adjust the degree to which the scanning time in the vicinity of the central portion of the projection area in the horizontal direction is closer to the scanning time in the vicinity of the end portions of the projection area in the horizontal direction.

With various preferred embodiments of the present invention, as was described above, even in cases where a scanner is provided which operates such that the scanning speed in the vicinity of the central portion of the projection area in the horizontal direction becomes faster than the scanning speed in the vicinity of the end portions, the luminance (brightness) of the entire screen is kept constant or substantially constant while significantly reducing or preventing any drop in the luminance (brightness) of the entire screen.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block diagram showing the configuration of the projector according to a preferred embodiment of the present invention.

FIG. 2 is a model diagram showing light scanned over the projection area by the MEMS mirror of the projector according to a preferred embodiment of the present invention.

FIG. 3 is a diagram showing the images projected onto the projection area of the projector according to a preferred embodiment of the present invention.

FIG. 4 is a diagram showing changes in the angle of deflection of the MEMS mirror during scanning in the horizontal direction in the projector according to a preferred embodiment of the present invention.

FIG. 5 is a graph showing the relationship between the scanning time and the scanning coordinate in the horizontal direction in the projector according to a preferred embodiment of the present invention.

FIG. 6 is a diagram showing changes in the luminance during scanning of the projection area in the horizontal direction of the projection area in the projector according to a preferred embodiment of the present invention.

### DETAILED DESCRIPTION OF THE PREFERRED EMBODIMENTS

Preferred embodiments of the present invention will be described below based on the drawings.

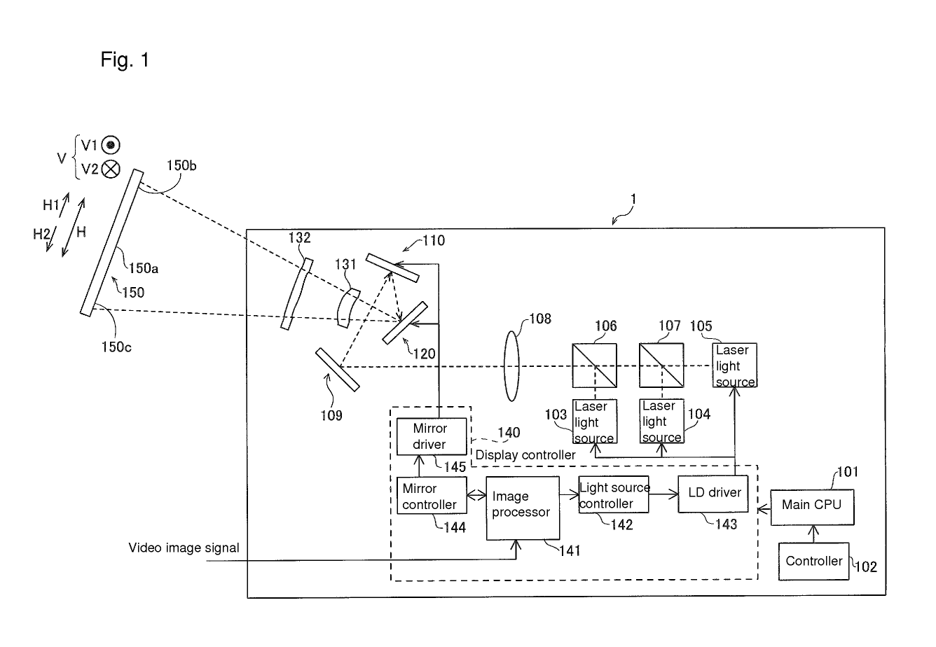

A configuration of the projector 1 according to a preferred embodiment of the present invention will be described with reference to FIGS. 1 to 4.

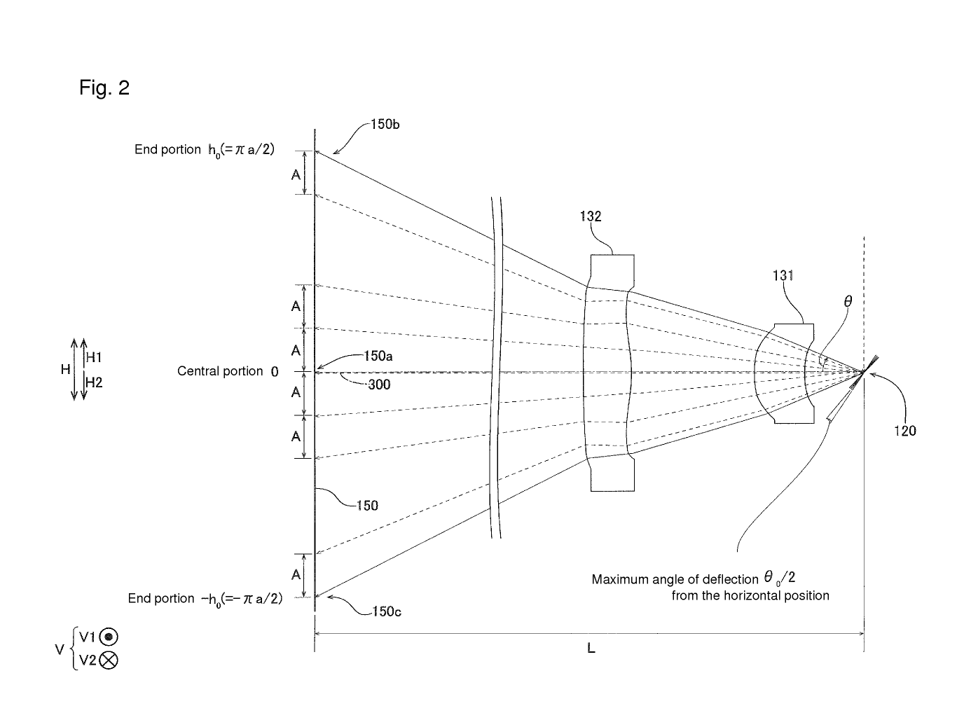

As shown in FIG. 1, the projector 1 according to a preferred embodiment of the present invention includes a main CPU 101, a controller 102, a plurality of (e.g., three) laser light sources 103 to 105, two polarizing beam splitters 106 and 107, and a lens 108. The projector 1 also includes a mirror 109 and MEMS (Micro Electro-Mechanical System) mirrors 110 and 120. Furthermore, as shown in FIG. 1 and FIG. 2, the MEMS mirrors 110 and 120 are configured to scan laser light over a projection area 150. Moreover, the projector 1 includes a first lens 131 and a second lens 132 that refract the light scanned by the MEMS mirrors 110 and 120. In addition, the projector 1 preferably includes a display controller 140 as shown in FIG. 1. The display controller 140 includes an image processor 141, a light source controller 142, an LD (laser diode) driver 143, a mirror controller 144, and a mirror driver 145. The projector 1 is configured so as to project images onto the projection area 150 based on video image signals input to the image processor 141. Note that the laser light sources 103 to 105 are merely one example of the “light source”. Furthermore, the MEMS mirror 120 is merely one example of the “oscillating mirror element” and “scanner”. Moreover, the first lens 131 is merely one example of the “optical member”.

The main CPU 101 is configured and programmed to control the various components of the projector 1. The controller 102 is configured and programmed to accept control actions such as turning on the power to the projector 1, changing the angle of projection of images, changing the resolution of the images, and so forth.

The laser light sources 103 to 105 are configured so as to respectively emit light of different wavelengths (colors). The laser light source 103 is configured so as to emit blue (B) laser light. The laser light source 104 is configured so as to emit green (G) laser light. The laser light source 105 is configured so as to emit red (R) laser light. The laser light source 103 is configured so as to pass blue laser light through the beam splitter 106 and the lens 108 and shine it onto the mirror 109. The laser light source 104 is configured so as to pass green laser light through the beam splitters 106 and 107 and the lens 108 and shine it onto the mirror 109. The laser light source 105 is configured so as to pass red laser light through the beam splitters 106 and 107 and the lens 108 and shine it onto the mirror 109.

In addition, as shown in FIG. 1, the lens 108 is disposed in a position between the polarizing beam splitters 106 and 107 and the mirror 109. The lens 108 is configured so as to make the laser light emitted from the laser light sources 103 to 105 parallel or substantially parallel. The mirror 109 is configured so as to reflect the laser light emitted from the laser light sources 103 to 105 toward the MEMS mirror 110. Furthermore, the mirror 109 is disposed in a state in which it is inclined at a specified angle with respect to the direction of travel of the laser light sources 103 to 105.

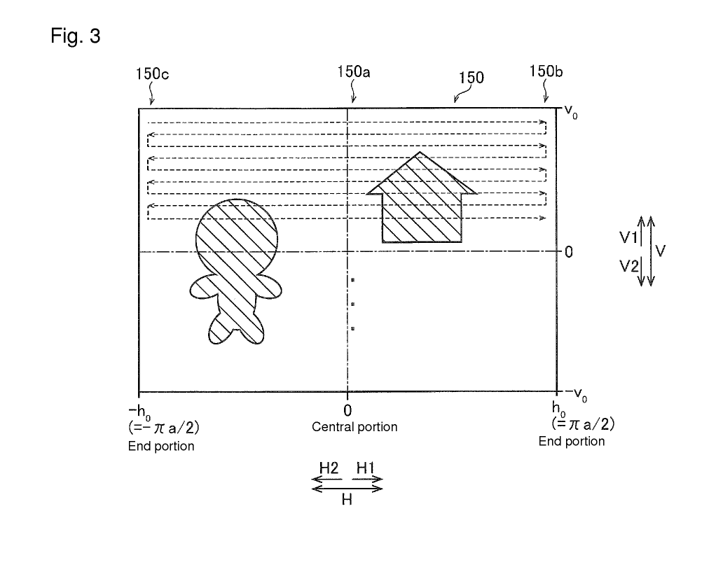

Moreover, the projection area 150 is configured such that an image is projected by the laser light scanned by the MEMS mirrors 110 and 120. As shown in FIG. 3, the MEMS mirror 110 (see FIG. 1) is configured so as to be driven in one axis and scan laser light in the vertical direction (V direction). In addition, taking the center of the projection area 150 in the V direction (vertical direction) to be the reference position 0, the MEMS mirror 110 is configured so as to scan laser light from the position v₀ farthest away from the reference position in the V1 direction to the position −v₀ farthest away in the V2 direction. Furthermore, the MEMS mirror 110 is configured so as to scan at low speed in the vertical direction under DC driving. Moreover, the MEMS mirror 110 is configured so as to be driven at a frequency of approximately 60 Hz and so as not to resonate.

Here, in the present preferred embodiment, as shown in FIG. 3, the MEMS mirror 120 (see FIG. 1) is configured so as to be driven in one axis and scan laser light in the horizontal direction (H direction). In addition, taking the center of the projection area 150 in the H direction (horizontal direction) to be the reference position 0, the MEMS mirror 120 is configured so as to scan laser light from the position h₀ farthest away from the reference position in the H1 direction to the position −h₀ farthest away in the H2 direction. Furthermore, the MEMS mirror 120 is configured so as to scan at high speed in the horizontal direction under resonant driving. The MEMS mirror 120 is configured so as to be driven at a frequency of approximately 25 kHz, for example, and so as to resonate.

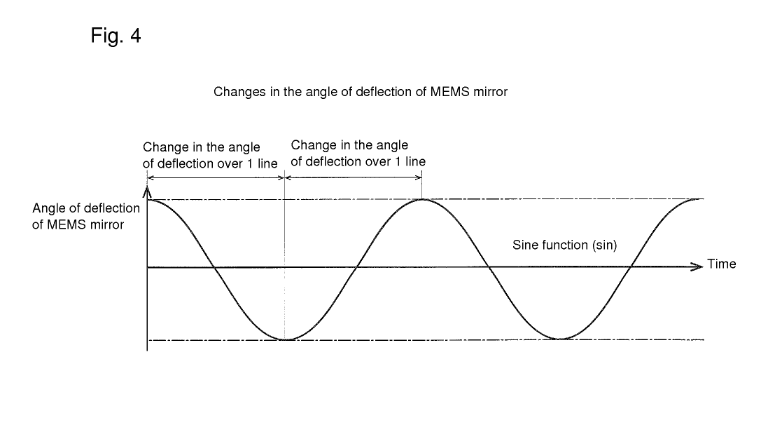

Moreover, as shown in FIG. 4, the MEMS mirror 120 is configured so as to operate at a specified angle of deflection such that the light emitted from the laser light sources 103 to 105 is scanned over the projection area 150 at a sine-function (sin) angular velocity in which the scanning speed in the vicinity of the central portion 150a of the projection area 150 in the horizontal direction (H direction) becomes faster than the scanning speed in the vicinity of the end portion 150b (150c). The scanning speed in the vicinity of the central portion 150a of the projection area 150 in the horizontal direction is faster than the scanning speed in the vicinity of the end portion 150b (150c). In addition, the MEMS mirror 120 is configured such that the maximum angle of deflection over which it can operate from the static state when scanning over the reference position 0 (see FIG. 2) of the projection area 150 is θ₀/2. Furthermore, this projector 1 is configured such that when the angle of deflection of the MEMS mirror 120 is at its maximum (θ₀/2), the angle (scanning angle) 0 spanning between the direction in which the laser light scanned (reflected) by the MEMS mirror 120 travels and the vertical line 300 dropped from the MEMS mirror 120 to the projection area 150 is θ₀. Moreover, the MEMS mirror 120 is configured such that the scanning speed (the speed of deflection of the MEMS mirror 120) varies periodically with respect to the scanning time. In addition, the scanning speed of the MEMS mirror 120 at a specified time period (the speed at which the MEMS mirror 120 deflects) is determined based on a differential coefficient at the specified time period.

Furthermore, as shown in FIG. 2, the angle (scanning angle) θ spanning between the direction in which the laser light scanned (reflected) by the MEMS mirror 120 travels and the vertical line 300 dropped from the MEMS mirror 120 to the projection area 150 has the relationship represented by Equation (1) below. Note that in Equation (1), f indicates the resonance frequency of the MEMS mirror 120, and t indicates the scanning time.

e=θ₀·sin(2πft) (1)

Moreover, the scanning time t and the scanning angle θ are related by the arcsine function (arcsin) as illustrated by Equation (2) below:

t=(½πf)·sin⁻¹(θ/θ₀) (2)

In the present preferred embodiment, furthermore, as shown in FIG. 2, the first lens 131 is disposed at a position between the MEMS mirror 120 and the projection area 150 and is configured so as to refract light scanned by the MEMS mirror 120 such that the scanning speed of the light scanned by the MEMS mirror 120 in the vicinity of the central portion 150a of the projection area 150 in the horizontal direction (H direction) becomes equal or substantially equal to the scanning speed in the vicinity of the end portion 150b (150c) in the horizontal direction.

The first lens 131 is configured so as to refract light scanned by the MEMS mirror 120 such that the scanning coordinate of the projection area 150 scanned by the MEMS mirror 120 is proportional or substantially proportional to the scanning time. In addition, the first lens 131 is configured such that, when the angle of deflection of the MEMS mirror 120 is substantially at the minimum (substantially 0°), it refracts light so as to change the scanning coordinate of the scanned light such that the scanning speed of the light in the vicinity of the central portion 150a of the projection area 150 in the horizontal direction (H direction) is equal or substantially equal to the scanning speed in the vicinity of the end portion 150b (150c) in the horizontal direction. Specifically, as shown in FIG. 2, the first lens 131 is configured so as to refract light that has been scanned by the MEMS mirror 120, thus reducing the amount of scanning per unit time (the scanning speed) in the vicinity of the central portion 150a of the projection area 150 in the horizontal direction and matching (compensating) this to the amount of scanning in the vicinity of the end portion 150b (150c) in the horizontal direction. Moreover, this state is illustrated in FIG. 2 by the amount of scanning of the projection area 150 per unit time in the horizontal direction (the scanning speed) indicated by the arrows A each having the same amount (width).

The scanning coordinate in the horizontal direction (H direction) and the scanning time of light refracted by the first lens 131 onto the projection area 150 preferably have a proportional relationship as illustrated by Equation (3) below. Note that in Equation (3) below, h indicates the scanning coordinate in the projection area, and a indicates a specified coefficient:

h=a·sin⁻¹(θ/θ₀) (3)

In addition, the first lens 131 is configured so as to refract light such that the scanning coordinate of the light scanned over the projection area 150 in the horizontal direction (H direction) is unchanged when the angle of deflection of the MEMS mirror 120 is substantially at the maximum (substantially θ₀/2). As a result of the first lens 131 being configured so as to have the relationship illustrated in Equation (4) below, the position of the scanning coordinate in the vicinity of the end portion 150b (150c) of the projection area 150 in the horizontal direction is unchanged. It is possible to significantly reduce or prevent any change in the size or shape of the image even if light reflected by the MEMS mirror 120 is refracted by the first lens 131. Note that in Equation (4), h₀ indicates the scanning coordinate in the projection area when the angle of deflection of the MEMS mirror 120 is substantially at the maximum, and L indicates the length of the vertical line 300 dropped from the MEMS mirror 120 to the projection area 150.

$$\begin{matrix}{h}_{0} = L \cdot tan {θ}_{0} \\ = a \cdot {sin}^{- 1} ( 1 rad ) \\ = π a / 2\end{matrix} \qquad ( 4 )$$

Furthermore, from Equation (4), the specified coefficient a is expressed by Equation (5) below:

a=(2/π)L·tan θ₀ (5)

From the foregoing, Equation (6) below is derived. The first lens 131 that has the relationship represented by Equation (6) below refracts light scanned by the MEMS mirror 120 such that the scanning coordinate on the projection area 150 scanned by the MEMS mirror 120 is proportional or substantially proportional to the scanning time.

h=(2/π)L·tan θ₀·sin⁻¹(θ/θ₀) (6)

Moreover, by incorporating a degree of compensation α into this Equation (6) as a coefficient, it is possible to adjust the degree to which the scanning speed in the vicinity of the central portion 150a of the projection area 150 in the horizontal direction (H direction) is closer to the scanning speed in the vicinity of the end portion 150b (150c) in the horizontal direction.

h=L·(tan θ₀/sin⁻¹(α))·sin⁻¹(α·θ/θ₀) (7)

In addition, using Equation (2) above, this Equation (7) can be expressed as Equation (8) below:

h=2πfL·(tan θ₀/sin⁻¹(α))×t (8)

Furthermore, the first lens 131 is configured such that the degree of compensation α in Equations (6) and (7) above satisfies the relation 0.6<α≦1. Note that in a case in which the first lens 131 is configured such that the degree of compensation α in Equations (6) and (7) above is 1, it is possible to make the scanning speed in the vicinity of the central portion 150a of the projection area 150 in the horizontal direction (H direction) nearly the same as the scanning speed in the vicinity of the end portion 150b (150c) in the horizontal direction (causing the scanning coordinate and scanning time to have a proportional relationship).

Moreover, in the present preferred embodiment, the second lens 132 is disposed at a position between the first lens 131 and the projection area 150 as shown in FIG. 1 and is configured so as to correspond to the wavelength of light emitted from each of the three laser light sources 103 to 105. In addition, the second lens 132 has the function of compensating for any aberration arising when the light having different wavelengths is refracted by the first lens 131. The second lens 132 is configured so as to refract the light of three different wavelengths emitted from the plurality of laser light sources 103 to 105 and refracted by the first lens 131 to substantially the same coordinates in the projection area 150.

The image processor 141 is configured and programmed so as to control the projection of images based on video image signals provided as input from outside. The image processor 141 is configured and programmed so as to control the driving of the MEMS mirrors 110 and 120 via the mirror controller 144 based on video image signals input from outside and also so as to control the radiation of laser light by the laser light sources 103 to 105 via the light source controller 142.

The light source controller 142 is configured and programmed so as to control the LD driver 143 based on control by the image processor 141, thus controlling the radiation of laser light by the laser light sources 103 to 105. The light source controller 142 is configured and programmed so as to perform control of the laser light of colors corresponding to the various pixels of the image to be emitted from the laser light sources 103 to 105 in coordination with the timing of the scanning of the MEMS mirrors 110 and 120.

The mirror controller 144 is configured and programmed so as to control the driving of the MEMS mirrors 110 and 120 by controlling the mirror driver 145 based on control by the image processor 141.

In the present preferred embodiment, as was described above, the first lens 131 that refracts light scanned by the MEMS mirror 120 is configured such that the scanning speed of the light scanned by the MEMS mirror 120 in the vicinity of the central portion 150a of the projection area 150 in the horizontal direction becomes equal or substantially equal to the scanning speed in the vicinity of the end portion 150b (150c) in the horizontal direction. Consequently, it is possible to compensate for the scanning time per unit of surface area in the vicinity of the central portion 150a of the projection area 150 in the horizontal direction so as to be equal or substantially equal to the scanning time per unit of surface area in the vicinity of the end portion 150b (150c) of the projection area 150 in the horizontal direction, so it is possible to significantly reduce or prevent any differences in the scanning time per unit of surface area (time of radiation of light (amount of radiated light)) between the vicinity of the central portion 150a and the vicinity of the end portion 150b (150c) in the horizontal direction. As a result, it is possible to significantly reduce or prevent cases in which the scanning time per unit of surface area (amount of radiated light) in the vicinity of the central portion 150a of the projection area 150 in the horizontal direction is less than the scanning time per unit of surface area (amount of radiated light) in the vicinity of the end portion 150b (150c), so the luminance (brightness) of the entire screen is kept constant or substantially constant while significantly reducing or preventing any drop in the brightness (luminance) of the entire screen.

In addition, in the present preferred embodiment, as was described above, the first lens 131 is configured so as to refract light such that the scanning coordinate of the projection area 150 scanned by the MEMS mirror 120 is proportional or substantially proportional to the scanning time. Thus, it is possible to compensate for the scanning time in the vicinity of the central portion 150a of the scanning area 150 in the horizontal direction so as to coincide or substantially coincide with the scanning time in the vicinity of the end portion 150b (150c) of the scanning area in the horizontal direction, so it is possible to easily make the time of radiation of light per unit of surface area (amount of radiated light) in the vicinity of the central portion 150a of the projection area 150 in the horizontal direction coincide or substantially coincide with the amount of radiation per unit of surface area in the vicinity of the end portion 150b (150c), and as a result, it is possible to make the luminance (brightness) of the images coincide or substantially coincide between the vicinity of the central portion 150a and the vicinity of the end portion 150b (150c) of the projection area 150 in the horizontal direction without any drop in the luminance (brightness) of the entire screen.

Furthermore, in the present preferred embodiment, as was described above, the first lens 131 is configured as follows. In cases where the angle of deflection of the MEMS mirror 120 is substantially at the minimum, it refracts light so as to change the scanning coordinate of the scanned light such that the scanning speed of the light in the vicinity of the central portion 150a of the projection area 150 in the horizontal direction is equal or substantially equal to the scanning speed in the vicinity of the end portion 150b (150c) in the horizontal direction, but in cases where the angle of deflection of the MEMS mirror 120 is substantially at the maximum, it refracts light such that the scanning coordinate of the light scanned over the projection area 150 is unchanged. Thus, it is possible to make the scanning time in the vicinity of the central portion 150a of the projection area 150 in the horizontal direction coincide with the scanning time in the vicinity of the end portion 150b (150c) while significantly reducing or preventing any changes to the size or shape of the image projected onto the projection area 150.

Moreover, in the present preferred embodiment, as was described above, the second lens 132 is provided which is disposed at a position between the first lens 131 and the projection area 150 and which corresponds to the wavelengths of light respectively emitted from the three laser light sources 103 to 105, and the second lens 132 is configured so as to refract the light of three different wavelengths refracted by the first lens 131 to substantially the same coordinates in the projection area 150. Thus, the second lens 132 compensates for any aberration arising when the light having different wavelengths is refracted by the first lens 131, so it is possible to significantly reduce or prevent any drop in the resolution of the image.

In addition, in the present preferred embodiment, as was described above, the first lens 131 is configured such that the relationship among the scanning coordinate h in the horizontal direction of the light scanned over the projection area 150 by the MEMS mirror 120, the distance L from the MEMS mirror 120 to the projection area 150, the resonance frequency f of the MEMS mirror 120, the maximum angle of deflection θ₀/2 at which the MEMS mirror 120 can operate, the scanning time t by the MEMS mirror 120, and the degree of compensation α to which the scanning speed in the vicinity of the central portion 150a of the projection area 150 in the horizontal direction is equal or substantially equal to the scanning speed in the vicinity of the end portion 150b (150c) in the horizontal direction satisfies the function h=2πL·(tan θ₀/sin⁻¹ (α))×t. Consequently, by adjusting the degree of compensation α, the degree to which the scanning time in the vicinity of the central portion 150a of the projection area 150 in the horizontal direction is made to coincide with the scanning time in the vicinity of the end portion 150b (150c) of the projection area 150 in the horizontal direction (the degree of compensation) is easily adjusted to the desired amount.

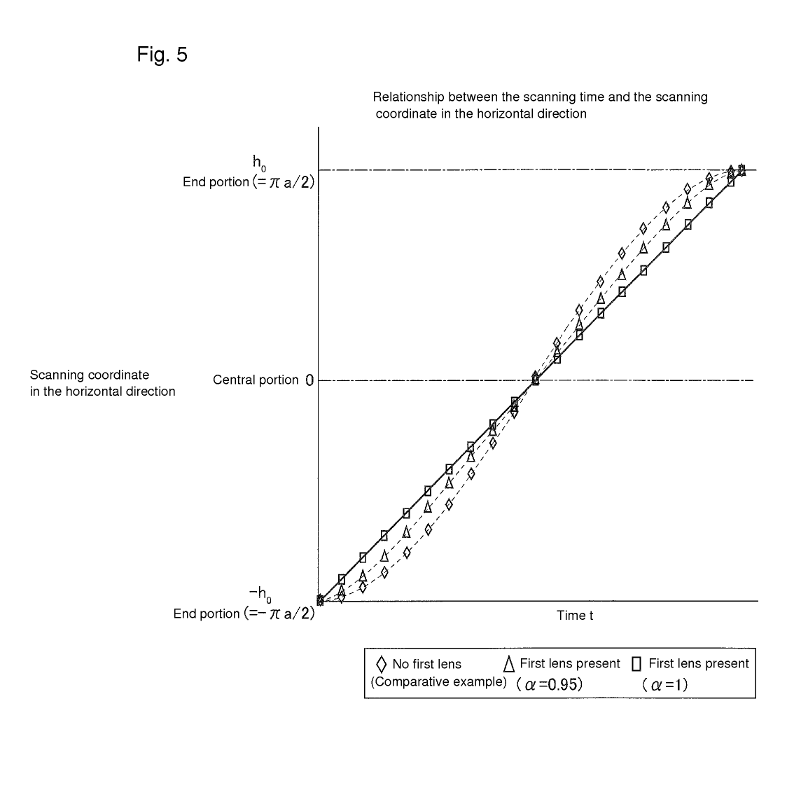

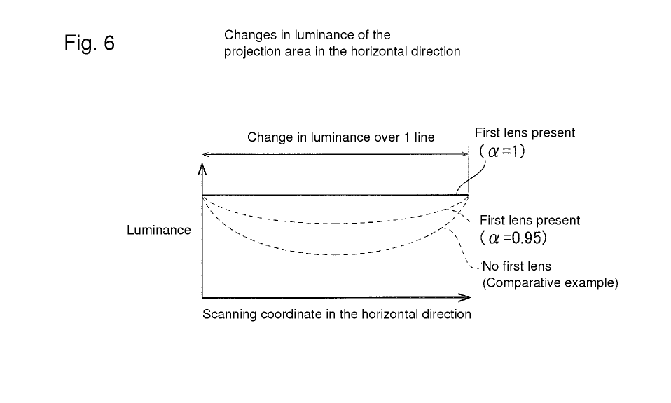

Next, FIG. 5 and FIG. 6 will be referenced to describe a comparison of a case in which a first lens 131 with a degree of compensation α of 1 is provided on the projector 1, a case in which a first lens 131 with a degree of compensation α of about 0.95 is provided, and, as a comparative example, a case in which no first lens 131 is provided.

FIG. 5 shows the results of a simulation of the scanning coordinate in the horizontal direction and the scanning time in the case in which a first lens 131 with a degree of compensation α of 1 is provided on the projector 1, the case in which a first lens 131 with a degree of compensation α of about 0.95 is provided, and the case in which no first lens 131 is provided.

In the case in which no first lens 131 is provided, it was confirmed that there is no proportional relationship between the scanning time and the scanning coordinate in the horizontal direction (H direction). Furthermore, it was confirmed that, in the case in which a first lens 131 with a degree of compensation a of about 0.95 is provided, the relationship between the scanning time and the scanning coordinate in the horizontal direction is somewhat more linear (closer to a proportional relationship) than in the case in which no first lens 131 is provided. Moreover, it was confirmed that in the case in which a first lens 131 with a degree of compensation α of 1 is provided, the scanning time and the scanning coordinate in the horizontal direction exhibit a proportional or substantially proportional relationship. Thus, as shown in FIG. 6, the closer the degree of compensation α is to 1, the greater the scanning time in the vicinity of the central portion 150a of the projection area 150 in the horizontal direction will be compensated to be closer to the scanning time in the vicinity of the end portion 150b of the projection area 150 in the horizontal direction, so it is possible to significantly reduce or prevent any differences in the scanning time per unit of surface area (time of radiation of light) between the vicinity of the central portion 150a and the vicinity of the end portion 150b of the projection area 150 in the horizontal direction. As a result, the closer the degree of compensation α is to 1, the more it is possible to significantly reduce or prevent differences in the luminance of the image between the vicinity of the central portion 150a and the vicinity of the end portion 150b of the projection area 150 in the horizontal direction.

Note that the preferred embodiment disclosed above merely constitutes an illustrative example in all respects and should be considered to be nonrestrictive. The scope of the present invention is indicated not by the description of the aforementioned preferred embodiment but rather by the scope of the claims, and it includes all modifications with an equivalent meaning and within the scope of the claims.

For instance, in the aforementioned preferred embodiment, an example was shown in which the first lens (optical member) and the second lens preferably are provided on the projector, but the present invention is not limited to this. In the present invention, it is also possible to provide the first lens (optical member) and the second lens on a head-up display (HUD), head-mounted display (HMD), and the like.

In addition, in the aforementioned preferred embodiment, an example was shown in which both the first lens (optical member) and the second lens preferably are provided, but the present invention is not limited to this. In other preferred embodiments of the present invention, only the first lens (optical member) may be provided, for example.

Furthermore, in the aforementioned preferred embodiment, an example was shown in which one second lens preferably is provided which compensates for aberrations arising when the light having different wavelengths is refracted by the first lens (optical member), but the present invention is not limited to this. In other preferred embodiments of the present invention, a plurality of second lenses may be provided. By doing this, the plurality of second lenses can be used to compensate for aberrations arising when the light having different wavelengths is refracted by the optical member, so it is possible to significantly reduce or prevent any drop in the resolution of the image even more. Moreover, by providing the same number of second lenses as the number of sources of light having different wavelengths, it is possible to compensate for aberrations for each source of light having a different wavelength individually, so it is possible to significantly reduce or prevent any drop in the resolution of the image to an even greater extent.

In addition, in the aforementioned preferred embodiment, examples were shown in which, in Equations (6) and (7) above, the degree of compensation α for making the scanning speed in the vicinity of the central portion of the projection area in the horizontal direction closer to the scanning speed in the vicinity of the end portions in the horizontal direction preferably is greater than about 0.6 and less than or equal to about 1, for example, but the present invention is not limited to this. In other preferred embodiments of the present invention, as long as the degree of compensation α is equal or substantially equal to about 1, it may also be α value greater than 0 and less than or equal to about 0.6, for example.

Furthermore, in the aforementioned preferred embodiment, a first lens (optical member) was shown which has the function of refracting light scanned by the MEMS mirror (scanner) so as to make the scanning speed of light scanned by the MEMS mirror in the vicinity of the central portion of the projection area in the horizontal direction closer to the scanning speed in the vicinity of the end portion in the horizontal direction, but the present invention is not limited to this. In other preferred embodiments of the present invention, for example, a prism or another optical member other than a lens may also be used as long as it has the aforementioned function.

Moreover, in the aforementioned preferred embodiment, an example was shown in which the MEMS mirrors 110 and 120 preferably are respectively disposed such that the laser light reflected by the MEMS mirror 110 driven in one axis and scanning laser light in the vertical direction (V direction) is reflected by the MEMS mirror 120 (scanner) driven in one axis and scanning laser light in the horizontal direction (H direction), but the present invention is not limited to this. In the present invention, it is also possible to respectively dispose the MEMS mirrors 120 and 110 such that the laser light reflected by the MEMS mirror 120 driven in one axis and scanning laser light in the horizontal direction is reflected by the MEMS mirror 110 driven in one axis and scanning laser light in the vertical direction. In addition, it is also possible to dispose a scanner that is driven in two axes and scans laser light in the vertical direction and in the horizontal direction.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A projector comprising:
a light source which emits light;
a scanner which operates at specified angles of deflection so as to scan light emitted from the light source over a projection area at a sine-function angular velocity in which a scanning speed in a vicinity of a central portion of the projection area in a horizontal direction is faster than a scanning speed in a vicinity of end portions; and
an optical member which is disposed at a position between the scanner and the projection area and which refracts light scanned by the scanner such that the scanning speed of the light scanned by the scanner in the vicinity of the central portion of the projection area in the horizontal direction is equal or substantially equal to the scanning speed in the vicinity of the end portions in the horizontal direction.

2. The projector according to claim 1, wherein the optical member is configured so as to refract light scanned by the scanner such that the scanning speed of the light scanned by the scanner in the vicinity of the central portion of the projection area in the horizontal direction is equal or substantially equal to the scanning speed in the vicinity of the end portions in the horizontal direction so as to make a scanning coordinate in the projection area scanned by the scanner proportional or substantially proportional to a scanning time.

3. The projector according to claim 1, wherein the optical member includes a first lens which refracts light scanned by the scanner such that the scanning speed of the light in the vicinity of the central portion of the projection area in the horizontal direction is equal or substantially equal to the scanning speed in the vicinity of the end portions in the horizontal direction.

4. The projector according to claim 3, wherein the first lens is configured such that, in cases where the angle of deflection of the scanner is equal or substantially equal to a minimum, the first lens refracts light so as to change a scanning coordinate of the light scanned by the scanner such that the scanning speed of the light in the vicinity of the central portion of the projection area in the horizontal direction is equal or substantially equal to the scanning speed in the vicinity of the end portions in the horizontal direction, but in cases where the angle of deflection of the scanner is equal or substantially equal to a maximum, the first lens refracts light such that the scanning coordinate of the light scanned over the projection area is unchanged.

5. The projector according to claim 3, wherein
the light source includes a plurality of light sources each of which emits light having a different wavelength;
a second lens is further provided which is disposed at a position between the scanner and the projection area and which corresponds to wavelengths of light respectively emitted from the plurality of light sources; and
the second lens is configured so as to refract the light of the plurality of different wavelengths respectively emitted from the plurality of light sources and refracted by the first lens to a same or substantially a same scanning coordinate in the projection area.

6. The projector according to claim 1, wherein
the scanner includes an oscillating mirror element that scans the light emitted from the light source over the projection area at the sine-function angular velocity; and
the optical member is configured so as to refract light scanned by the scanner such that the scanning speed of the light scanned by the oscillating mirror element in the vicinity of the central portion of the projection area in the horizontal direction is equal or substantially equal to the scanning speed in the vicinity of the end portions in the horizontal direction.

7. The projector according to claim 1, wherein the optical member is configured such that a relationship among a scanning coordinate h in the horizontal direction of the light scanned over the projection area by the scanner, a distance L from the scanner to the projection area, a resonance frequency f of the scanner, a maximum angle of deflection θ₀/2 at which the scanner operates, a scanning time t scanned by the scanner, and a degree of compensation α making the scanning speed in the vicinity of the central portion of the projection area in the horizontal direction closer to the scanning speed in the vicinity of the end portions in the horizontal direction satisfies a function h=2πfL·(tan θ₀/sin⁻¹ (α))×t.
